(19) United States
(12) Patent Application Publication
(10) Pub. No.: US 2016/0328795 A1
(43) Pub. Date: Nov. 10, 2016

(54) SYSTEM AND METHOD FOR IDENTIFYING AND SECURING LOW RISK LOANS

(71) Applicants: Deborah Ann Doughty, Greenville, DE (US); Steven Paul Walczak, Greenville, DE (US)

(72) Inventors: Deborah Ann Doughty, Greenville, DE (US); Steven Paul Walczak, Greenville, DE (US)

(21) Appl. No.: 15/149,879

(22) Filed: May 9, 2016

Related U.S. Application Data
(60) Provisional application No. 62/158,362, filed on May 7, 2015.

(51) Int. Cl. G06Q 40/02

(52) U.S. Cl. CPC G06Q 40/025

(57) ABSTRACT

The present invention provides an engine, system and method for identifying and offering of an attractive loan to particularly situated debtors. More particularly, the invention allows for the processing of real-time financial information and the optimization of tradition termed loan offerings to individuals who have a relatively small amount of revolving debt and meet certain risk criteria.

### CROSS REFERENCE TO RELATED APPLICATIONS

This application claims priority to U.S. Patent Application Ser. No. 62/158,362, filed May 7, 2015, the entire contents of which are incorporated herein by reference.

### FIELD OF THE INVENTION

The present invention relates to the identification and exploitation of low credit risk loan opportunities and the securing and turnover of replacement credit.

### BACKGROUND OF THE INVENTION

Although a debtor may have sufficient funds to pay off an outstanding high rate loan, some debtors may wish to continue the loan for various reasons, including, for example, to conserve available cash and/or through an unwillingness to take the time to investigate and obtain a loan having more favorable terms. In the present marketplace, these customers are difficult to identify and are often not offered a product which either meets their needs or is attractive enough for the debtor.

Thus, there is a need for a system that allows for the identification and offering of an attractive loan to particularly situated debtors. More particularly, there is a need for an engine, system and method to provide identify debtors having high credit worthiness who are in loans having less optimal terms than at least one which may be offered.

### SUMMARY OF THE INVENTION

The present invention provides an engine, system and method for identifying and offering of an attractive loan to particularly situated debtors.

More particularly, the present invention comprises a computer-implemented engine for generating a loan proposal, over a network, responsively to input customer information comprising at least one certified information input, comprising a graphical user interface capable of locally querying an origination engine for the input customer information comprising at least general consumer information and the at least one certified information input, at least one network port capable of remotely receiving the consumer information from the graphical user interface, and at least one rules engine communicatively connected to the at least one network port, and comprising a plurality of rules to generate, responsively to the input consumer information, a debt instrument for offer to at least one consumer.

### BRIEF DESCRIPTION OF THE DRAWINGS

The accompanying drawings are included to provide a further understanding of the disclosed embodiments. In the drawings:

FIG. 1 is a block diagram of an exemplary computing system for use in accordance with herein described systems and methods;

FIG. 2 is a block diagram showing an exemplary networked computing environment for use in accordance with herein described systems and methods;

FIG. 3 illustrates a chart showing an exemplary embodiment of the present invention in accordance with the herein described systems and methods;

FIG. 4 illustrates a flowchart showing an exemplary embodiment of the present invention in accordance with the herein described systems and methods;

FIG. 5 illustrates a flowchart showing an exemplary embodiment of the present invention in accordance with the herein described systems and methods; and

FIG. 6 illustrates a system diagram showing an exemplary embodiment of the present invention in accordance with the herein described systems and methods.

### DETAILED DESCRIPTION

A computer-implemented platform and methods of use are disclosed that provide systems and methods for discerning and offering loans to targeted debtors. Described embodiments are intended to be exemplary and not limiting. As such, it is contemplated that the herein described systems and methods can be adapted to provide many types of loans to debtors, and can be extended to provide enhancements and/or additions to the exemplary services described. The invention is intended to include all such extensions. Reference will now be made in detail to various exemplary and illustrative embodiments of the present invention.

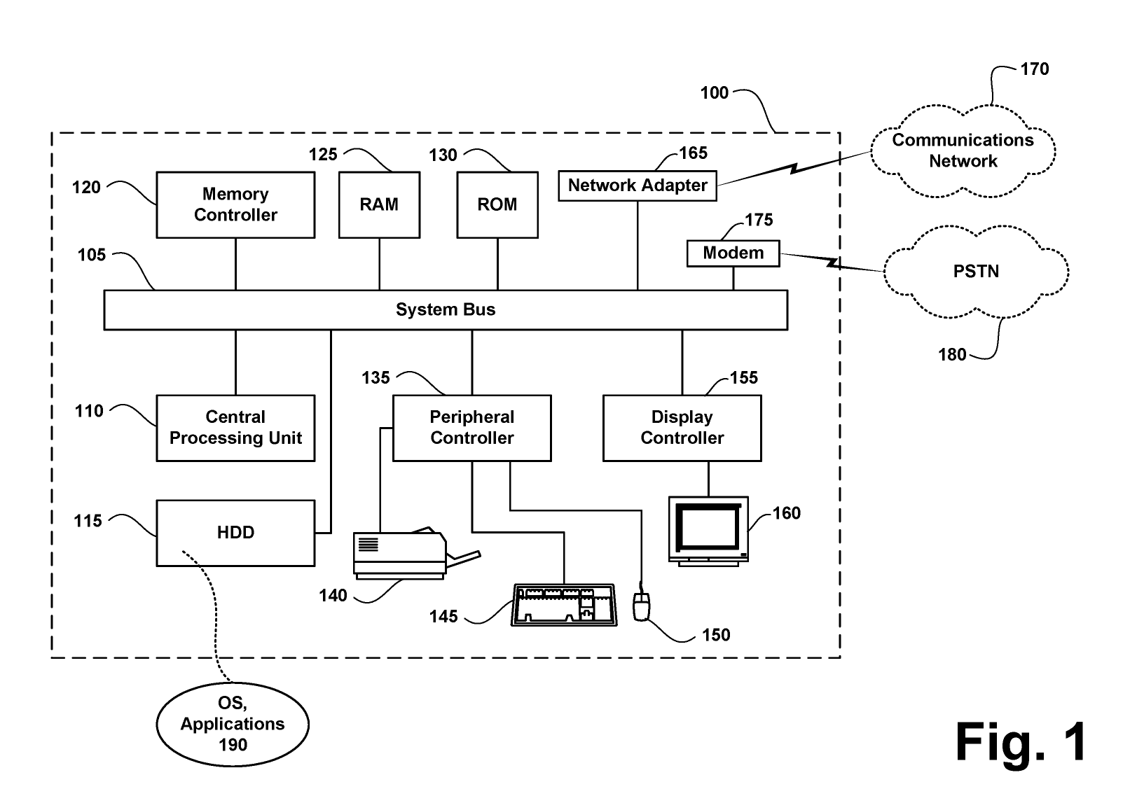

FIG. 1 depicts an exemplary computing system 100 that can be used in accordance with herein described system and methods. Computing system 100 is capable of executing software, such as an operating system (OS) and a variety of computing applications 190. The operation of exemplary computing system 100 is controlled primarily by computer readable instructions, such as instructions stored in a computer readable storage medium, such as hard disk drive (HDD) 115, optical disk (not shown) such as a CD or DVD, solid state drive (not shown) such as a USB “thumb drive,” or the like. Such instructions may be executed within central processing unit (CPU) 110 to cause computing system 100 to perform operations. In many known computer servers, workstations, personal computers, mobile devices, and the like, CPU 110 is implemented in an integrated circuit called a processor.

It is appreciated that, although exemplary computing system 100 is shown to comprise a single CPU 110, such description is merely illustrative as computing system 100 may comprise a plurality of CPUs 110. Additionally, computing system 100 may exploit the resources of remote CPUs (not shown), for example, through communications network 170 or some other data communications means.

In operation, CPU 110 fetches, decodes, and executes instructions from a computer readable storage medium such as HDD 115. Such instructions can be included in software such as an operating system (OS), executable programs, and the like. Information, such as computer instructions and other computer readable data, is transferred between components of computing system 100 via the system's main data-transfer path. The main data-transfer path may use a system bus architecture 105, although other computer architectures (not shown) can be used, such as architectures using serializers and deserializers and crossbar switches to communicate data between devices over serial communication paths. System bus 105 can include data lines for sending data, address lines for sending addresses, and control lines for sending interrupts and for operating the system bus. Some busses provide bus arbitration that regulates access to the bus by extension cards, controllers, and CPU 110. Devices that attach to the busses and arbitrate access to the bus are called bus masters. Bus master support also allows multiprocessor configurations of the busses to be created by the addition of bus master adapters containing processors and support chips.

Memory devices coupled to system bus 105 can include random access memory (RAM) 125 and read only memory (ROM) 130. Such memories include circuitry that allows information to be stored and retrieved. ROMs 130 generally contain stored data that cannot be modified. Data stored in RAM 125 can be read or changed by CPU 110 or other hardware devices. Access to RAM 125 and/or ROM 130 may be controlled by memory controller 120. Memory controller 120 may provide an address translation function that translates virtual addresses into physical addresses as instructions are executed. Memory controller 120 may also provide a memory protection function that isolates processes within the system and isolates system processes from user processes. Thus, a program running in user mode can normally access only memory mapped by its own process virtual address space; it cannot access memory within another process' virtual address space unless memory sharing between the processes has been set up.

In addition, computing system 100 may contain peripheral controller 135 responsible for communicating instructions using a peripheral bus from CPU 110 to peripherals, such as printer 140, keyboard 145, and mouse 150. An example of a peripheral bus is the Peripheral Component Interconnect (PCI) bus.

Display 160, which is controlled by display controller 155, can be used to display visual output generated by computing system 100. Such visual output may include text, graphics, animated graphics, and/or video, for example. Display 160 may be implemented with a CRT-based video display, an LCD-based display, gas plasma-based display, touch-panel, or the like. Display controller 155 includes electronic components required to generate a video signal that is sent to display 160.

Further, computing system 100 may contain network adapter 165 which may be used to couple computing system 100 to an external communication network 170, which may include or provide access to the Internet, and hence which may provide or include tracking of and access to the domain data discussed herein. Communications network 170 may provide user access to computing system 100 with means of communicating and transferring software and information electronically, and may be coupled directly to computing system 100, or indirectly to computing system 100, such as via PSTN or cellular network 180. For example, users may communicate with computing system 100 using communication means such as email, direct data connection, virtual private network (VPN), Skype or other online video conferencing services, or the like. Additionally, communications network 170 may provide for distributed processing, which involves several computers and the sharing of workloads or cooperative efforts in performing a task. It is appreciated that the network connections shown are exemplary and other means of establishing communications links between computing system 100 and remote users may be used.

It is appreciated that exemplary computing system 100 is merely illustrative of a computing environment in which the herein described systems and methods may operate and does not limit the implementation of the herein described systems and methods in computing environments having differing components and configurations, as the inventive concepts described herein may be implemented in various computing environments using various components and configurations.

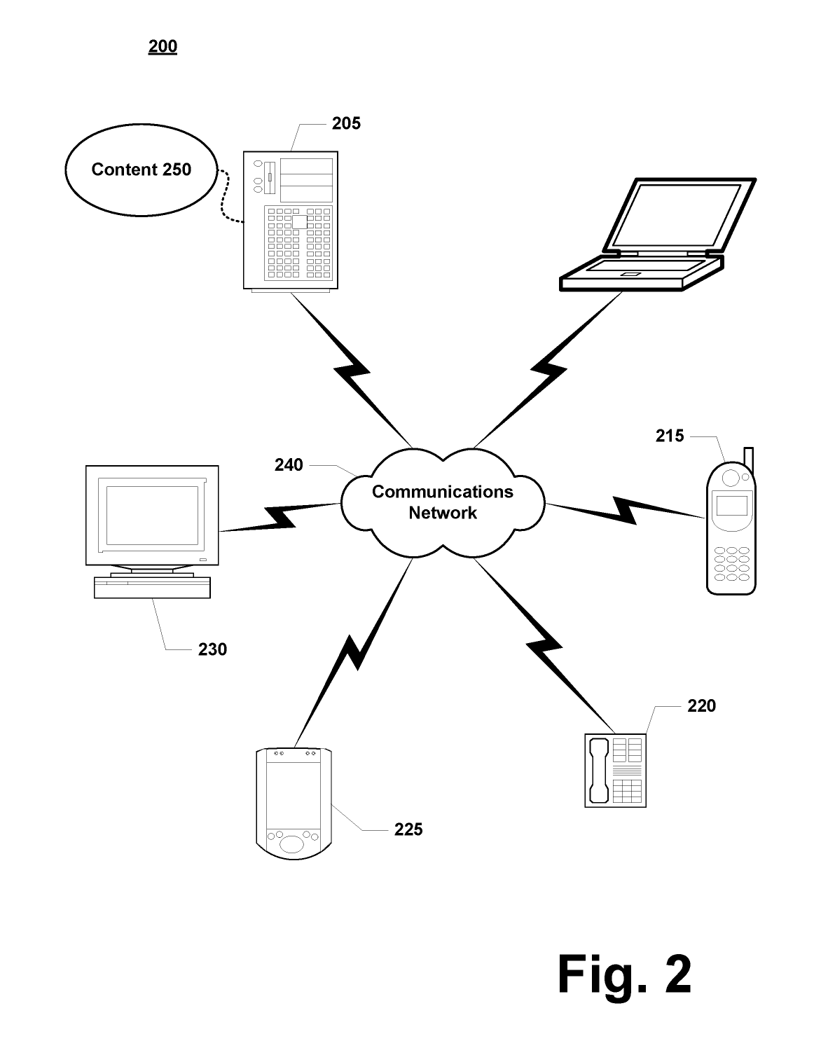

As shown in FIG. 2, computing system 100 can be deployed in networked computing environment 200. In general, the above description for computing system 100 applies to server, client, and peer computers deployed in a networked environment, for example, server 205, laptop computer 210, and desktop computer 230. FIG. 2 illustrates an exemplary illustrative networked computing environment 200, with a server in communication with client computing and/or communicating devices via a communications network, in which the herein described apparatus and methods may be employed.

As shown in FIG. 2, server 205 may be interconnected via a communications network 240 (which may include any of, or any combination of, a fixed-wire or wireless LAN, WAN, intranet, extranet, peer-to-peer network, virtual private network, the Internet, or other communications network such as POTS, ISDN, VoIP, PSTN, etc.) with a number of client computing/communication devices such as laptop computer 210, wireless mobile telephone 215, wired telephone 220, personal digital assistant 225, user desktop computer 230, and/or other communication enabled devices (not shown). Server 205 can comprise dedicated servers operable to process and communicate data such as digital content 250 to and from client devices 210, 215, 220, 225, 230, etc. using any of a number of known protocols, such as hypertext transfer protocol (HTTP), file transfer protocol (FTP), simple object access protocol (SOAP), wireless application protocol (WAP), or the like. Additionally, networked computing environment 200 can utilize various data security protocols such as secured socket layer (SSL), pretty good privacy (PGP), virtual private network (VPN) security, or the like. Each client device 210, 215, 220, 225, 230, etc. can be equipped with an operating system operable to support one or more computing and/or communication applications, such as a web browser (not shown), email (not shown), or independently developed applications, the like, to interact with server 205.

The server 205 may thus deliver applications specifically designed for mobile client devices, such as, for example, client device 225. A client device 225 may be any mobile telephone, PDA, tablet or smart phone and may have any device compatible operating system. Such operating systems may include, for example, Symbian, RIM Blackberry OS, Android, Apple iOS, Windows Phone, Palm webOS, Maemo, bada, MeeGo, Brew OS, and Linux for smartphones and tablets. Although many mobile operating systems may be programmed in C++, some may be programmed in Java and .NET, for example. Some operating systems may or may not allow for the use of a proxy server and some may or may not have on-device encryption. Of course, because many of the aforementioned operating systems are proprietary, in prior art embodiments server 205 delivered to client device 225 only those applications and that content applicable to the operating system and platform communication relevant to that client device 225 type.

JavaScript Serialized Object Notation (JSON), a lightweight, text-based, language-independent data-interchange format, is based on a subset of the JavaScript Programming Language, Standard ECMA-262, 3.sup.rd Edition, dated December 1999. JSON syntax is a text format defined with a collection of name/value pairs and an ordered list of values. JSON is very useful for sending structured data over wire (e.g., the Internet) that is lightweight and easy to parse. It is language and platform independent, but uses conventions that are familiar to C-family programming conventions. The JSON language is thus compatible with a great many operating systems (a list of such systems is available at www.json.org).

The techniques described herein may be used for various wireless communication networks, such as CDMA, TDMA, FDMA, OFDMA, SC-FDMA, and other wireless networks. The terms “network” and “system” are often used interchangeably herein. By way of example, a CDMA network may implement a radio technology such as Universal Terrestrial Radio Access (UTRA), cdma2000, and the like. For example, an OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, and the like. UTRA and E-UTRA are part of Universal Mobile Telecommunication System (UMTS). UTRA, E-UTRA, UMTS, as well as long term evolution (LTE) and other cellular techniques, are described in documents from an organization named “3rd Generation Partnership Project” (3GPP) and “3rd Generation Partnership Project 2” (3GPP2).

“WiFi” stands for “Wireless Fidelity.” WiFi is typically deployed as a wireless local area network (WLAN) that may extend home and business networks to wireless medium. As referenced, the IEEE 802,11 standard defines WiFi communications as between devices, and as between devices and access points. WiFi typically provides aggregate user data speeds from 2 Mbps (for 802.11b) to approximately 150 Mbps (for 802.11n). Typical speeds for WiFi are around 15 Mbps, and latency (i.e., packet delay) averages around 10 ms with no load. WiFi may link devices, and/or devices and access points, over distances from a few feet to several miles. By way of contrast, LTE, as mentioned above, typically provides WAN connectivity that may stretch for much greater distances, but is typically not preferred for LAN communications. Of note, the techniques described herein may be used for the wireless networks and radio technologies mentioned above, as well as for other wireless networks and radio technologies.

WiFi networks, herein also referred to as IEEE 802.11 wireless networks, may operate in two modes: infrastructure mode and ad-hoc mode. In infrastructure mode, a device connects to an access point (AP) that serves as a hub for connecting wireless devices to the network infrastructure, including, for example, connecting wireless devices to Internet access. Infrastructure mode thus uses a client-server architecture to provide connectivity to the other wireless devices. In contrast to the client-server architecture of infrastructure mode, in ad-hoc mode wireless devices have direct connections to each other in a peer-to-peer architecture.

As a percentage of the number of loans originated by traditional lending institutions, the greatest lending activity has been in the sub to near prime segments, with less activity in the prime to prime+segments. This is a result of, at least in part, economic demographics and the value potential of the loans originated. More plainly, there are more people who have less than perfect credit than not and the loans originated to those with lesser credit scores are often accompanied by higher interest rates. Although these loan may present a higher risk of default to the lender, they may also present a higher rate of return through the increased interest rate the lender is able to charge along with other fees.

Loans having higher rates of return coupled with a higher risk profile are often personal loans not collateralized against an asset. However attractive such loans are, in general, large banking institutions are either once active or never active due to the difficulty of successfully identifying the lowest risk persona loans within this higher risk market. Traditionally, identifying the more optimal loans required intensive research into the potential debtor, not only as to current financial status, but to past history related to the payment of loans and the ability to satisfy a loan through at least a relatively consistent income.\

Thus, traditional loan making included the provision of a basic loan, which generally related to the accommodation business for those debtors at or near sub-prime to near prime. Although such debtors were not traditionally targeted, if they were, they were qualification oriented, and only even considered through a customer initiated process or to solve a problem with other debts associated with the same banking institution. Such loan products were likely passive offerings given the lending institutions general dislike of such debtors. Lending institution would also generally rely on traditionally scored credit decisions and would limit such loans and would not include such loans as the focus of any lending program.

Traditional personal loans have general been deployed for the accommodation of the customer and have been offered in the sub-prime to near prime market segments. Due to the accommodation focus of such loans, they are generally not targeted to any specific customer segment and have historically been used to provide a solution for small and short term customer needs. Such loans have therefore generally been passively offered while being reliant on traditional credit score decision and predetermined value propositions. Without any specific organizational focus, such products have not historically been viewed or utilized in sales efforts by lending institutions.

Dedicated personal loans, however, may be a vehicle which may provide the opportunity to economically exploit and increase market penetration of the personal loan segment. At their heart, dedicated personal loans are proactively managed and offered to prime and better customers for whom a personal loan is not otherwise needed to fulfill an urgent need (a need that would often have the consumer coming to request such a loan from the bank versus the bank approaching the consumer. Dedicated personal loans are a targeted product driven by customer opportunities and a positive selection process. The lending institution, or a broker, for example, may identify a consumer who meets or exceeds certain predetermined thresholds and may then tailor a dedicated personal loan offering to best fir the customer's needs and provide the most optimal return for the lender.

In the dedicated personal loan marketplace, over 14 million bowers have above average FICO scores and more than $8,000 in revolving debt. This market segment represents more than $200 billion dollars of potential loan activity. Although some traditional lending sources have entered this market, those that participate generally offer limited products given the mis-understood risks and the lack of understanding relative to economically viable products. Thus, for example, various pee-to-peer lenders have begun to enter the market place and allow for consumers to access various versions of a dedicated personal loan. However, the current state of the art fails to teach how to proactively locate and offer tailored loans to a wide variety of consumers.

At its core, a dedicated personal loan may be designed for use by consumers with good to better credit scores who also have some form of revolving debt. Such debt often takes the form of credit card debt and may result from short term cash flow issue, for example. Of the over 200 million people in the United States for whom a loan can be made based on some sort of credit history, less than ten (10%) percent may be suitable for a dedicated personal loan.

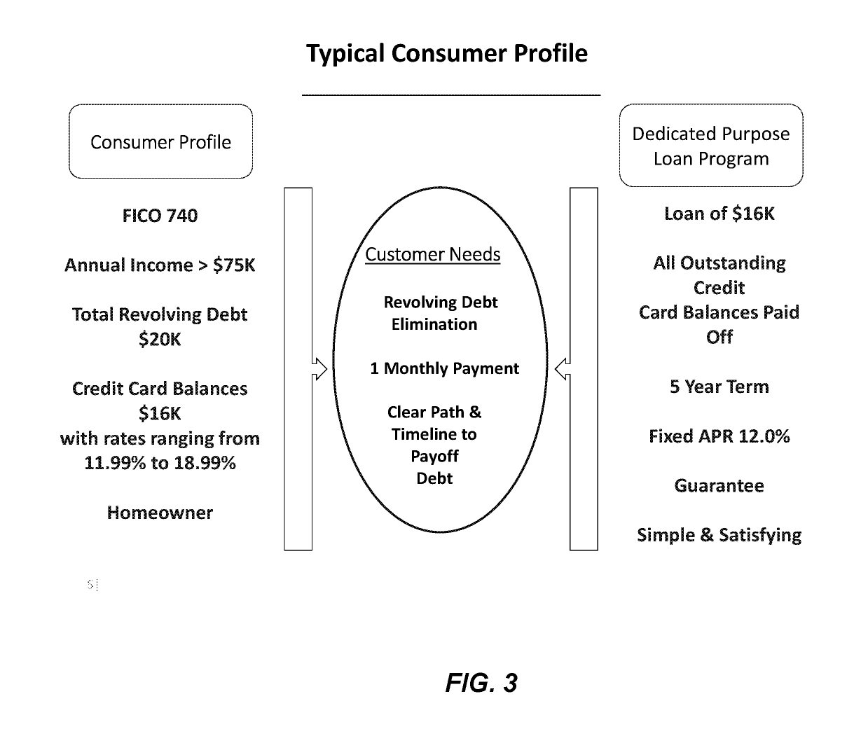

FIG. 3 illustrates a typical profile of the targeted dedicated purpose loan offeree. In general, a targeted consumer will have an above average credit score, generally one over 740 as taken from known sources, and an annual income of greater than $75,000. The targeted consumer may have about $20,000 in revolving debt and be a homeowner. What may be most important, from at least a sales prospective, is that the targeted consumer will have at least $3,500 in credit card balances with relatively high interest rates. Preferably, the targeted consumer will have credit card balances of between $5,000 and $16,000 having an interest rate of between 11% and 20%. In such a scenario, offered terms are more likely than not to be accepted.

Against this consumer profile, the present invention may formulate an offering which may be likely accepted by the consumer. For example, a loan may be offered to cover one or more debts held by the consumer and may, for example, be used to pay off one or more revolving debts. Terms of such a lump sum may include a term of years, such as five, and an APR of about twelve (12% percent) for example, and may further be fixed. Such loans may offer a consumer a fixed APR and may provide a consumer a better chance of paying off the loan(s) they may have under one umbrella product.

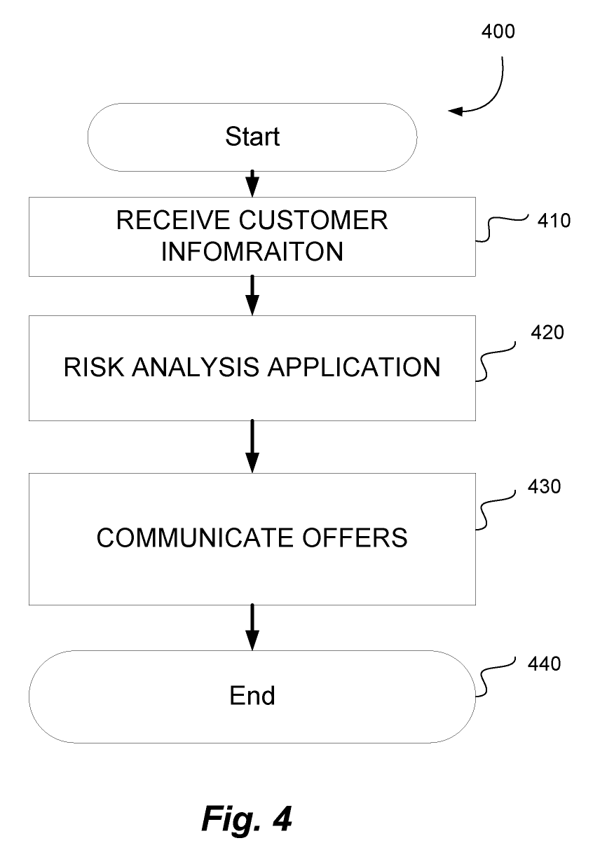

As illustrated in FIG. 4, the present invention may begin a process 400 which may first receive customer information 410 which may consist of a plurality of consumer information packets which may include a majority of the information necessary to perform a risk analysis 420. Such information may include the necessary consumer identification information, debt load of the consumer and type of debt incurred, credit worthiness, demographic information, income status, and like characteristic information.

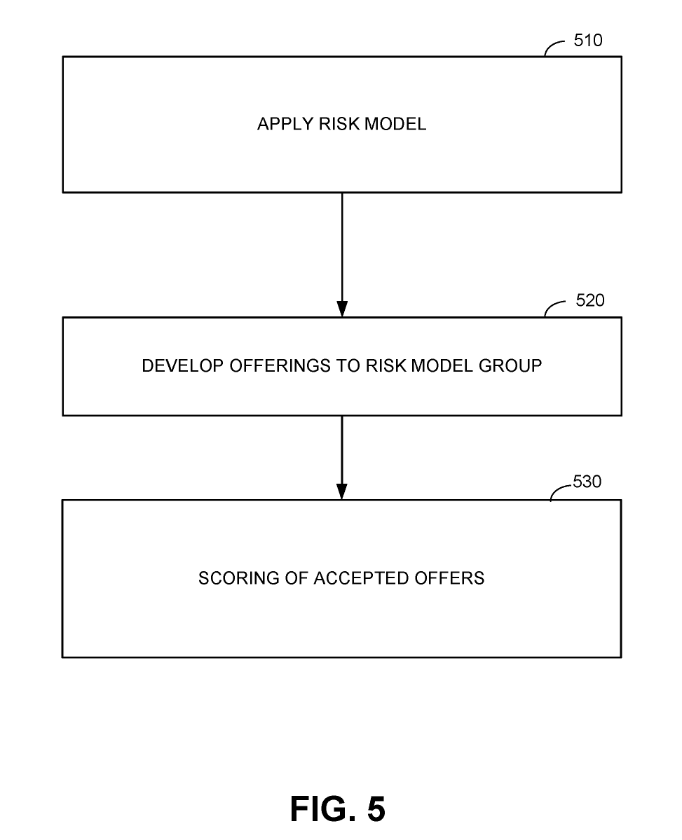

As illustrated in FIG. 5, a risk model provided at step 510 of an aspect of the present invention may be deployed to filter some of the possible consumers. The risk model may take into account various consumer attributes such as, for example, FICO score, payment history, debt load, type of revolving debt, consumer location, employment status, income, and loan history. At step 520 of an aspect of the present invention, offerings may be developed for at least a subset of those customers passing through the risk model at step 510. Such offerings may include contingent aspects which may require consumer consent and/or additional information from the potential dedicated personal loan recipient. For example, a potential consumer may be asked to confirm his/her employment status, income/cash flow, current debt obligations, health and marital status, for example. A potential consumer may also be asked to consent to processes required by the specific dedicated personal loan offering. Process criteria for the dedicated personal loan offering may include, for example, a requirement for auto draft of amounts due, wage garnishment, interest rate, and other payment terms.

At step 530, an aspect of the present invention may score offers accepted by or responded to by the consumers who met or exceeded the criteria of the risk models in at least step 510. Offers may be reviewed to confirm the information provided by the consumer and may be again, if the more updated numbers are not a match to those original used for a risk analysis, subject to step 510 to ensure that the information provided by the consumer meets or exceeds the product offering terms and remains an acceptable risk. Step 530 may help reduce the number of suboptimal offerees by providing a score based on the offerees finally provided information. The scoring may, for example, provide a negative weighting for suboptimal results and neutral to positive weightings for optimal information. Although the weighting may take any form, a numerical system may be the easiest to employ.

Thus, for example, if an offeree provides current information indicative of a reduced cash flow that previously known, the offeree may be given a minus (−1) one weighing for that attribute. Such a weighting may be further refined by allowing for a moving scale commensurate with the percent change in reported income versus previously known. Thus a less than ten (10%) change may result in a minus (−1) one weighing for that attribute, while a negative fifteen (15%) percent change may result in a minus (−3) three weighing for that attribute. Similarly, an increase in reported income over previously known income may result in the same or other weighted increase in score, such that a ten (10%) increase in reported income versus known income may provide the offeree's application with at least a plus (+1) one weighting for that attribute. As those skilled in the art will understand, the scale by which positive and negative reporting is scored may be scaled and may be dependent on additional factors, For example, the scale may be a influenced by the time between changes in the offerees income and may, for example, take into account seasonal income effects.

Using the risk models above, the present invention may provide to a lending institution delineated selection of target customers who fit at least some of the criteria necessary to make a loan offer to consumers with sufficient debts needs and fit at least some of the other financial characteristics. The present invention may also provide various models and pricing for a variety of offerings and may optimize each offering to each customer identified by the present invention. This optimization will provide to each consumer or at least each type of consumer an offer tailored to each set of characteristics to push the acceptance rate of such loan offers to greater than eighty (80%) percent. For example, with revolving debt of greater the twenty (20) thousand and a FICO score of greater than 700, a loan of about sixteen ($16,000) dollars for a term of about fifty seven (57) months at an APR of about twelve (12%) percent.

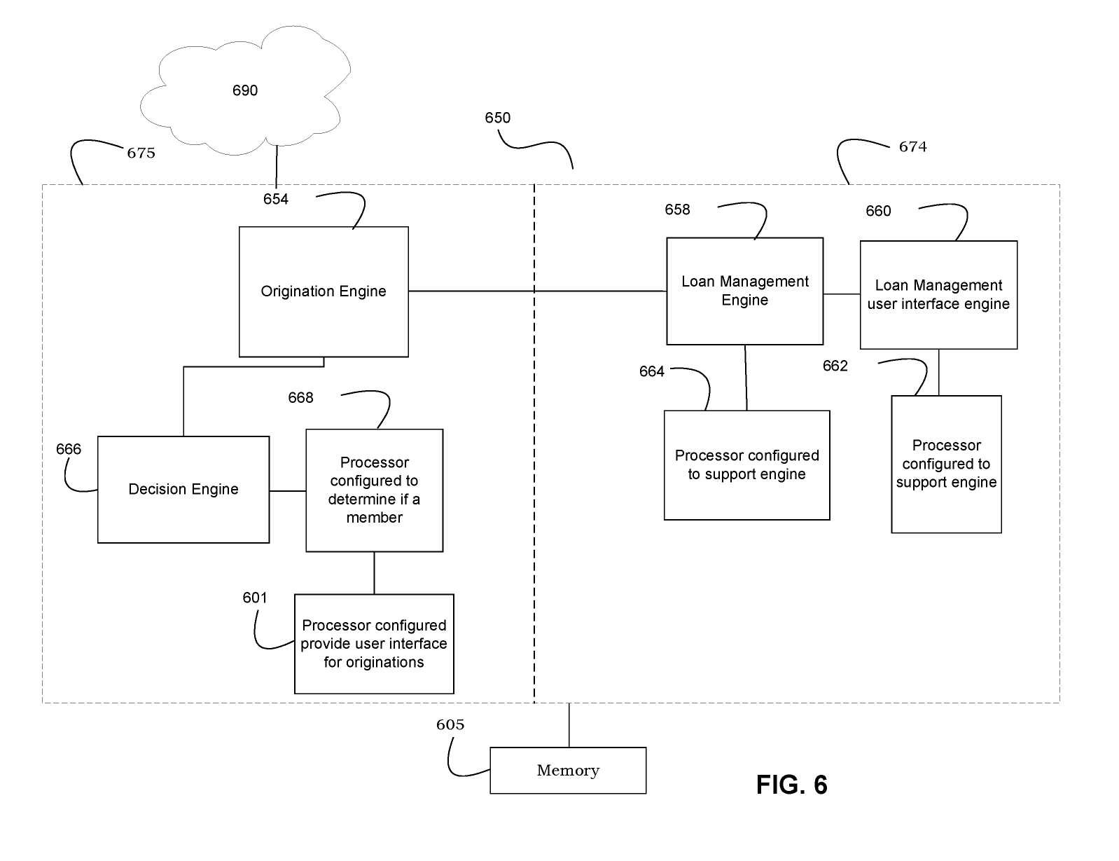

Referring now to FIG. 6, the present invention may provide a process machine 650 which may include a plurality of processors for the purpose of executing specific areas of code. Information may first be provided to process machine 650 by memory 605 which may comprise known memory sources as mentioned above such as, for example, RAM or DDS. The process machine 650 may further comprise an origination process 675 and a loan management process 674. As would be understood by those in the art, process machine 650 may be viewed as a modular system that may be resident on various types of servers and may have added thereto any number of processes which may be necessary. Such connection to other modules, information, servers, and/or third party platforms, for example, may be achieved with use of the internet connection 690.

The origination processor 675 may comprise a processor configured to provide a user interface for originations 601. Such a “GUI” may be provided to allow for the collection of consumer information from at least memory 605 and may be an operator-facing GUI and/or a passive gateway. Processor 601 may receive information about a plurality of consumers in the form of an aggregated list and may perform various task on the information to conform the information for suitability within process machine 650. Conforming the received data may comprise renaming various data headers, restricting received data to only necessary information, conforming of numerical information, conforming of alphanumeric information, and the like, to be suitable for use in process machine 650.

To provide a confidence level of accuracy within the present invention and to provide for security features, both internal to the process machine 650 of the present invention and to those individuals whose information is being processed, processor 668 is employed to, in part, determine if a consumer is part of the member group associated with the particular lender and if the user of the process machine 650 is an authorized user. Although such security measure maybe bifurcated, the user of process machine 650 may be provided a predetermined security key which may be associated with the information to be uploaded and/or provided to the process machine 650, thus providing, at least in part, for certified information input. As may be understood by those skilled in the art, the security of sensitive financial information can be paramount in the face of federal and state regulations and potential liability

A decision engine 666 may also be resident in process machine 650 and, more particularly, may be associated with origination process 675. Decision engine 666 may perform at least a first filtering of the possible offerees by looking at various of the characteristics discussed herein related to each of the potential offerees. The decision engine may further be dynamically tuned to take into account the various users and or lending institutions accessing the process machine 650. In this way, the present invention may make decisions based on criteria specific to each user or lending institution. For example, the decision engine 666 may apply a predetermined set of filtering criteria based on the known type of the user, such as, for example, when the user is identified as a savings and loan institution. Filtering criteria may also be tailored to a specific user, such as an individual savings and loan institution, when the system identifies a specific characteristic of that user, such as its geographic location, or if the system receives specific criteria instructions. Information such as geographic location may inform the system as to the demographic and economic profile of the user's customer base. Other information, including the user's identify, may inform the system, such as by accessing known lending terms and characteristics of the user themselves.

Once the decision engine 666 has processed the available user information, the origination engine 654 may be employed to create offers for the offerees and to optimize such offers based on various dynamically changing information provided by the user and taken from real-time real world market conditions. In this way, the origination engine 654 may provide a plurality of offers in real-time responsive to actual market conditions and in line with real-time customer information. This type of bundling of time sensitive loan offers has not been otherwise possible and creates a distinct market advantage for the lending institution. Not only does the user have the opportunity to offer a plurality of loans at substantially the same time, but the information is current enough to provide a strategic advantage over competitors by, in part, driving the risks generally associated with stale offers whose information may have changed during the processing/offering period.

In addition to providing an actual offer package per offeree, the origination engine 654 may optimization each of the loans offered to include use of a risk profile and various risk inputs. For example, risk inputs may include incident rates by risk deciles, change-off curve by term, repayment rate curve, a bad to good ratio, and loss rates by term/deciles. Other optimization inputs may include a gathered survey of then offered rates by other lending institutions—a function which may be carried out by the origination engine 654. Other factors which may be considered by the origination engine 654 may include, but are not limited to, current stock market indications, time of the year—including both secular and religious holidays, consumer price index, consumer confidence survey(s), election cycles, geography, weather, and political events, for example.

In an embodiment of the present invention, basic P&L inputs of the lender may be used, such as, costs of funds, CPA by risk deciles, loan amount by risk deciles, operating costs, and fees/re-pricing income. Various applications of these inputs, as well as other parameters discussed herein, may be applied such as using a multiplier to improve modeling profitability and to minimize the effects of other unaccounted for pressures on the overall acceptance and profitability of the loan product offered to the offeree. For example, a ten (10) times multiplier may be used against certain risk deciles—such as those having a low FICO score, for example, to create a better comparison against other risk deciles and/or other individual offerings from a particular decile.

Referring again to FIG. 6, the loan management processor 674 of the process machine 650 may be local to the origination processor 675 and may preform final processing of potential loan offers for a lending institution. In an embodiment of the present invention, the loan management processor 674 may be tailored to a specific lender and may be locally resident at or discretely accessible by a specific lending organization. The loan management engine 658 may receive processed loan packages from the origination processor 675 and may include at least one database for the storage of received information, separate and apart from any other database associated with process machine 650 (not shown).

The loan management engine 658 may have a discrete processor 664 associated therewith either locally or remotely through such means as cloud computing, for example. Loan management engine 658 may provide the lending institution with the ability to score potential offers, as discussed herein, and to then select at least a subset of the potential loans from the origination processor 675 to pursue. In some instances, the lending institution may simply hold or delete unwanted loan offers and/or may inform the origination processor 675 and have the unused loan offers recycled and/or updated for future consideration.

In an embodiment of loan management user interface 660, supported by processor 662, may be used and/or accessed by either financial institutions and/or the potential offerees. For example, a user from a lending organization may review various loans proposed through the loan management engine 658 and may have the ability to further manipulate such offers. For example, the potential offers may be in a sortable list allow the user to review and select the top fifty (50%) percent most lucrative offers. Similarly, the user may look to target a specific APR range, FICO score group and/or other risk decile, for example. In any event, the user may be able to manually select and alter the terms of any number of offers before they are communicated to an offeree. The loan management user interface may also allow for offeree access to their own offer and may allow for the offeree to accept, decline, or counter-offer the terms of the proposed loan. This on-line flexibility may allow for the offer to be more easily communicated over mobile devices, for example, and may provide the lender with more real-time and consistent interaction with the target offeree.

Those of skill in the art will appreciate that the herein described systems and methods are susceptible to various modifications and alternative constructions. There is no intention to limit the scope of the invention to the specific constructions described herein. Rather, the herein described systems and methods are intended to cover all modifications, alternative constructions, and equivalents falling within the scope and spirit of the invention and its equivalents.

What is claimed is:

1. A computer-implemented engine for generating a loan proposal, over a network, responsively to input customer information comprising at least one certified information input, comprising:
a graphical user interface capable of locally querying an origination engine for the input customer information comprising at least general consumer information and the at least one certified information input;
at least one network port capable of remotely receiving the consumer information from said graphical user interface; and
at least one rules engine communicatively connected to said at least one network port, and comprising a plurality of rules to generate, responsively to the input consumer information, a debt instrument for offer to at least one consumer.
